(19) United States
(12) Patent Application Publication
(10) Pub. No.: US 2022/0105731 A1
(43) Pub. Date: Apr. 7, 2022

(54) INK AND TREATMENT MATERIAL FILLING SYSTEM HAVING A SINGLE RECEPTACLE COMPATIBLE FOR MULTIPLE INK CARTRIDGES

(71) Applicant: TWINE SOLUTIONS LTD., Petach Tikva (IL)

(72) Inventors: Alon NAVON, Even Yehuda (IL); Yoram ZILBERBERG, Tel Aviv (IL); Moti BALAISH, Netanya (IL); Yoav ROSENBACH, Ramat Gan (IL); Shalom LEVIN, Atlit (IL); Asaf LEVIN, Atlit (IL); Alon MOSHE, Petach Tikva (IL)

(73) Assignee: TWINE SOLUTIONS LTD., Petach Tikva (IL)

(21) Appl. No.: 17/424,180

(22) PCT Filed: Jan. 20, 2020
(86) PCT No.: PCT/IL2020/050080

§ 371 Date: Jul. 20, 2021

Related U.S. Application Data
(60) Provisional application No. 62/794,728, filed on Jan. 21, 2019.

(51) Int. Cl. B41J 2/175

(52) U.S. Cl. CPC B41J 2/17506

(57) ABSTRACT

Embodiments described herein are systems for filling machines which use treatment materials contained in cartridges. Optionally, the machine is a dyeing machine, and the treatment material is ink. Some embodiments relate to a liquid management system for conveying a plurality of unique treatment liquids, comprising: a first receptacle adapted to receive a single cartridge, the receptacle having multiple conduits, each conduit configured to transport a unique liquid, and each conduit corresponding to a different position on a cartridge; a plurality of cartridges configured to contain a liquid, the cartridges each comprising a flow outlet located at a position in the cartridge corresponding to one of the conduits of the receptacle; wherein, when a filled cartridge is introduced into the receptacle, liquid may flow through the flow outlet and into one of the conduits of the receptacle.

### FIELD

Provided herein are systems for filling inks or other treatment materials for use in digital printing and dyeing applications.

### BACKGROUND

In industrial settings, treatment materials in liquid form, are applied to products of manufacture during various stages of manufacture. A treatment material may be applied to a substrate in the form of a product or a raw material to change its appearance, texture or other physical qualities. A chemical or biological reagent may be used as a treatment material to change the qualities of a substrate. An exemplary treatment material used for changing color is an ink. Inks are used in many applications including, but not limited to digital printing and digital dyeing processes. PCT application PCT/IL2016/050789 discloses a digitally controlled dyeing process. In digital dyeing, an ink is applied to a substrate such as a thread. Optionally, a digital dyeing apparatus comprises a dyeing head. A substrate is conveyed past a dyeing head and the dyeing head is configured to apply an ink or other treatment material to the substrate. The color of the ink or the nature of the treatment material emitted by the dyeing head on to or into the substrate may change, in accordance with a pre-determined pattern as controlled by a digital control. Digital printing may be a type of digital dyeing in which a treatment material is applied to a substrate.

In both home and industrial settings, inks for digital printing and dyeing processes may be packaged in a cartridge. A cartridge is a convenient and common means to transport ink from a manufacturer to an end user. The end user may insert the filled cartridge into the printing or dyeing machine, obviating the need to pour or measure the ink. Cartridges may be configured to be disposed of after the ink is completed, or, cartridges may be refilled.

Machines for digital dyeing (and printing) may use a plurality of liquids such as inks at the same time. For example, the machine may utilize controlled amounts of cyan, magenta, yellow, and black inks in varied combinations to imprint or embed a color to a substrate. The colored inks are from one or more than one of cyan, magenta, yellow, and black inks in varying amounts. Such machines typically have individual reservoirs for each of the aforementioned colored inks, each reservoir being a cartridge containing one of the colored inks. During operation, a cartridge comprising a colored ink or other treatment material is inserted into a cartridge bay configured to receive the cartridge and transfer the material from the cartridge to the machine. The machine, if used for color printing or dyeing, has a unique cartridge bay dedicated to each one of the colors (cyan, magenta, yellow and black) or treatment materials used by it.

Cartridges may be used as means to transport liquids from a manufacturer of the liquid to a user.

### SUMMARY

Described herein are systems for filling machines which use treatment materials contained in cartridges. Optionally, the machine is a dyeing machine, and the treatment material is ink. The systems allow for effective filling of the machine and emptying waste from the machine. The systems are advantageous relative to previously known systems as they allow machines to have a single port configured to receive a single cartridge, wherein the cartridge may comprise one of a plurality of treatment materials. With respect to dyeing machines, the systems are advantageous relative to previously known systems as they allow dyeing machines to have a single port configured to receive a single cartridge, wherein the cartridge may comprise one of a plurality of inks. The single port is configured to accept cartridges having inks of different colors. Optionally, the dyeing machine is a digital dyeing machine.

Some embodiments relate to systems for filling dyeing (or printing) machines that use treatment material to treat a substrate, the systems using cartridges for effective filling and emptying waste from the dyeing machine.

Security measures for maintaining proper function of treatment processes, including dyeing, are also described herein.

Some embodiments relate to a liquid management system for conveying a plurality of unique treatment liquids, comprising: a first receptacle adapted to receive a single cartridge, the receptacle having multiple conduits, each conduit configured to transport a unique liquid, and each conduit corresponding to a different position on a cartridge; a plurality of cartridges configured to contain a liquid, the cartridges each comprising a flow outlet located at a position in the cartridge corresponding to one of the conduits of the receptacle; wherein, when a filled cartridge is introduced into the receptacle, liquid may flow through the flow outlet and into one of the conduits of the receptacle.

Further embodiments relate to a cartridge for use with a liquid management system for conveying a plurality of unique liquids to a receptacle adapted to receive a single cartridge and having multiple conduits, each conduit configured to transport a unique liquid, and each conduit corresponding to a different position on a cartridge; the cartridge comprising multiple openable conduits, each conduit located at a position in the cartridge corresponding to one of the conduits of the receptacle; a plurality of openable conduits of the cartridge are sealed to prevent liquid flow through the cartridge conduits, and one of the openable conduits is fitted with a valve to form a flow outlet in the cartridge; wherein, when a filled cartridge is introduced into the receptacle, liquid may flow through the flow outlet and into one of the conduits of the receptacle.

There are numerous advantages to the liquid management systems described herein. The liquid management systems are environmentally friendly in that cartridges can be reused to store waste after being emptied from their original content. In addition, filling systems described herein occupy less room than standard filling systems, as one dock may be used to house multiple different types of cartridges, each holding a distinct type of treatment liquid. This feature also allows design flexibility in machines using the cartridges. Filling systems described herein also reduce human error associated with introduction of a treatment liquid into an inappropriate liquid reservoir.

The foregoing and other objects, features, and advantages will become more apparent from the following detailed description, which proceeds with reference to the accompanying figures.

### BRIEF DESCRIPTION OF THE DRAWINGS

FIGS. 1A and 1B are schematic diagrams of a filling system shown in constructed (1A) and exploded (1B) views;

FIGS. 2A and 2B are schematic diagrams of cartridges for use in a filling system, shown in front upper perspective (2A) and rear upper perspective (2B) views;

FIGS. 3A, 3B and 3C are schematic diagrams of cartridges for use in a filling system, shown in rear lower perspective views;

FIGS. 4A and 4B are schematic diagrams of a security flap and associated security features of a cartridge;

FIG. 5 is a schematic diagram of a bay for a cartridge, and security features associated with the bay.

### DETAILED DESCRIPTION

### Terms

Unless otherwise noted, technical terms are used according to conventional usage.

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” The abbreviation, “e.g.” is derived from the Latin exempli gratia and is used herein to indicate a non-limiting example. Thus, the abbreviation “e.g.” is synonymous with the term “for example.”

In case of conflict, the present specification, including explanations of terms, will control. In addition, all the materials, methods, and examples are illustrative and not intended to be limiting.

Ink: a composition comprising a colorant, such as a dye for coloring a substrate and a liquid medium possibly including other additives. An ink may be contacted with a substrate such as a thread or a fabric to color it permanently. An ink may have dye, pigment or other colorant dissolved or suspended in the liquid medium.

Treatment Material: any kind of material that can be used for dyeing, coating or changing properties of a substrate such as but not limited to dye materials, coating materials for coating the threads or portions thereof with protective materials, treatment-materials designed to enhance properties of the substrate such as for strengthening the substrate, pharmaceutical, cosmeceutical and/or nutraceutical materials for adding cosmetic or medical properties to the substrate such as for adding pharmaceutical to a substrate. A treatment liquid is a treatment material in liquid form.
The treatment material may be an ink, coating material, dye effect material, or other liquid medium having a property such as but not limited to conductive material, magnetic material, biological active material, lubricant, or a chemical treatment-material. The treatment materials used by the thread treatment machine can be any liquid, including polymeric or gel type materials. Exemplary treatment materials include: ink, or fast-dry inks. Additional exemplary treatment materials include dye effect materials for producing glittering or glowing effects or a dotted effect. Optionally, treatment material that can be used either alone or in conjunction with an ink may be non-visible materials that affect the thread functional characteristics such as tensile strength or conductivity.
Substrate: The substrate may be a material that is treated with at least one treatment material. Exemplary substrates include: thread, filament, fiber, cord, strand, yarn, and fabric.

### Overview of Several Embodiments

Some of the embodiments described below relate to an ink filling system. Alternate embodiments of the invention contain similar components to those described below but are used with reference to treatment liquids other than inks.

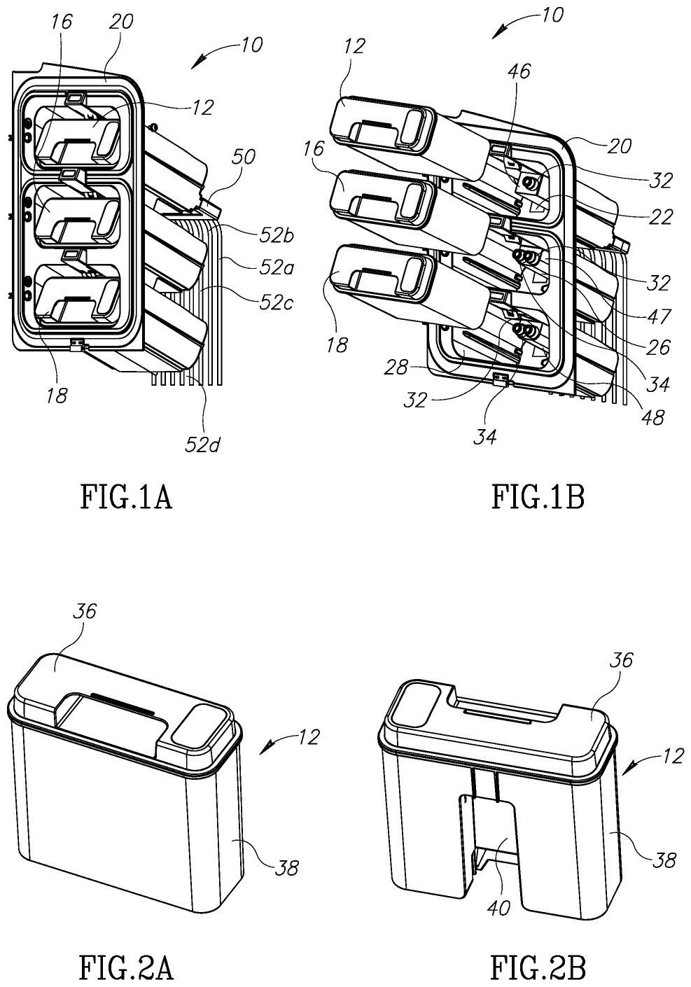

Reference is now made to FIGS. 1A and 1B, which depict an ink filling system 10. Filling system 10 includes cartridges 12, 16 and 18. Cartridge 12 may be filled with one of a number of colored inks. After emptying of cartridge 12, it may be used to receive waste from the dyeing machine as cartridge 16 or 18. Filling system 10 includes a bay 20, which has a conduit housing 50, and any number of conduits, such as conduits 52a, 52b, 52c, and 52d . Conduits 52a, 52b, 52c, and 52d are flow-connected at one end to cartridge 12 and at the opposite end to a reservoir configured for containing an ink or other liquid. FIG. 1B depicts a filling system 10 in a semi-exploded view. Bay 20 has docks 22, 26 and 28 which serve as receptacles for the cartridges. Docks 22, 26 and 28 respectively have mating abutments 46, 47 and 48 whose function is described below in conjunction with FIG. 5. Dock 22 includes an air conduit 32 on abutment 46 for transfer of air to cartridge 12. Dock 26 includes an air conduit 32 and a waste conduit 34 on abutment 47, and dock 28 includes an air conduit 32 and a waste conduit 34 on abutment 48. Waste conduit 34 transfers waste to cartridges 16 and 18. Cartridge 12 is configured to fit in dock 22. Cartridge 12 may also fit in dock 26 and 28 after emptying of cartridge 12. Cartridge 16 is configured to fit in dock 26. Cartridge 16 may also fit in dock 28 and 22. Cartridge 18 is configured to fit in dock 28. Cartridge 18 may also fit in dock 26 and 22.

Filling system 10 was depicted with bay 20 having 3 docks, 1 configured to introduce ink or other treatment materials, and two waste filling. Alternate embodiments relate to systems comprising between 2 and 100 docks for introduction of ink or other treatment material or for waste filling.

Reference is now made to FIGS. 2A and 2B which respectively depict a front upper perspective view and rear upper perspective view of cartridge 12. Cartridge 12 has a bin 38 and a lid 36. Bin 38 and lid 36 may be sealed together to prevent liquid flow through the joint between them. Bin 38 and lid 36 may be sealed through heat-welding or any other means. Cartridge 12 may further have a groove 40 which mates with abutment 46.

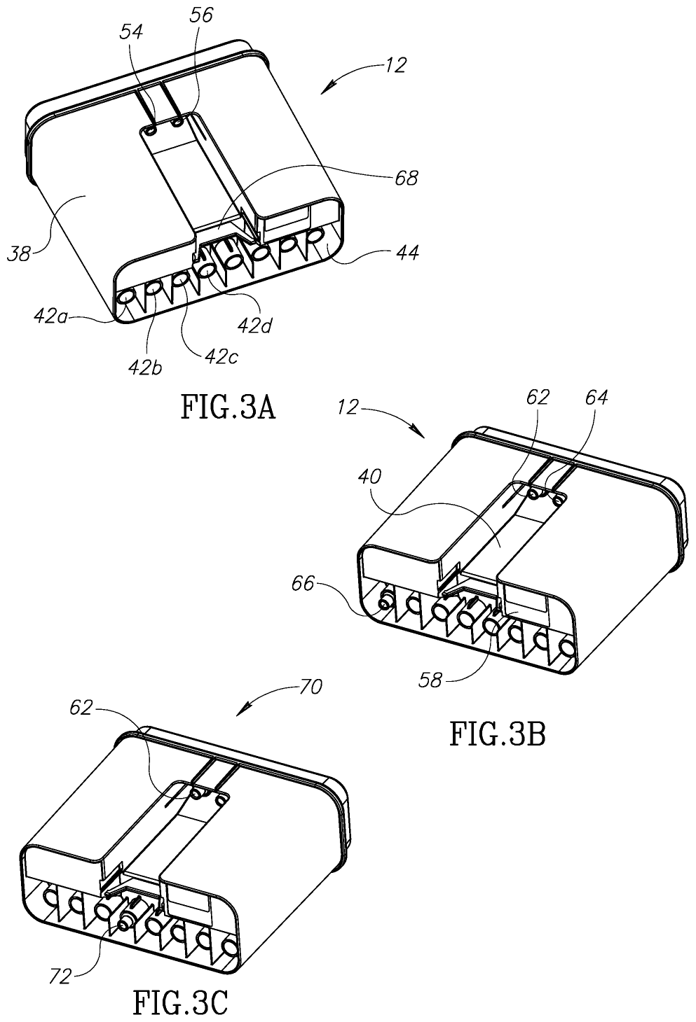

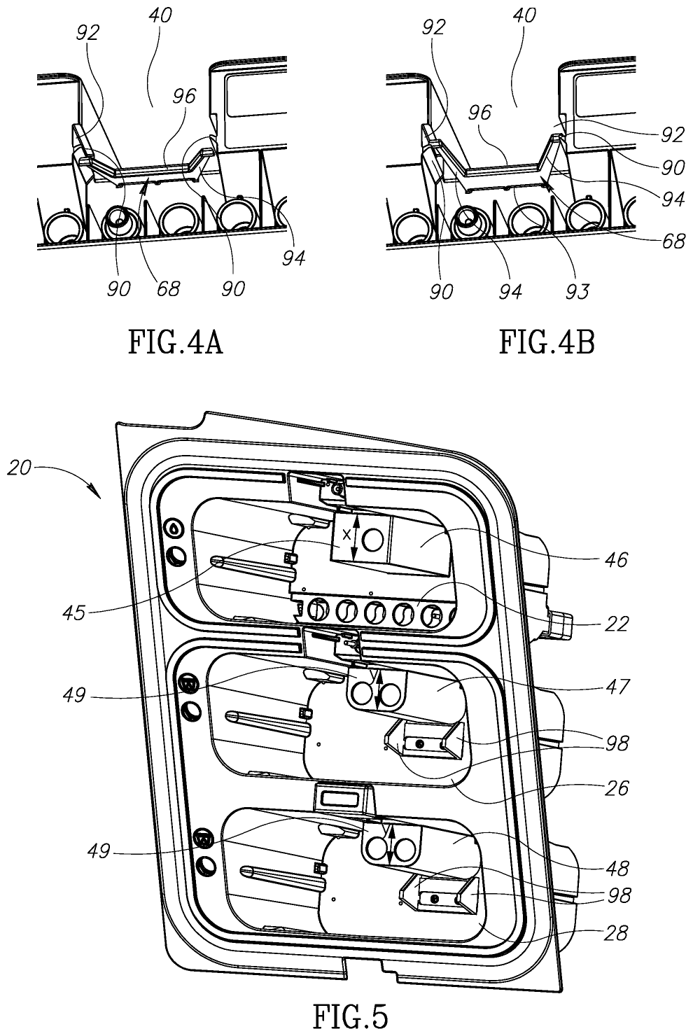

Reference is now made to FIG. 3A, which depicts a rear lower perspective view of cartridge 12, prior to insertion of valves 62, 64 and 66 (see FIG. 3B) in conduits. Bin 38 of cartridge 12 has an air conduit 54 and a waste conduit 56 located in an upper section of cartridge 12, within groove 40. Cartridge 12 further includes at its lower base, fluid conduits 42a, 42b, 42c and 42d. Optionally, cartridge 12 may comprise between 2 and 8 fluid conduits. Optionally, cartridges may comprise more than 8 fluid conduits each. Cartridge 12 includes a lower rim 44, extending distally beyond the distal ends of fluid conduits 42a-d. Fluid conduits 42a-d, may be sealed upon manufacture of cartridge 12. Before filling of cartridge 12, one of 42a-d may be opened for the insertion of a valve. Air conduit 54 and waste conduit 56 may be sealed upon manufacture of cartridge 12, and before filling of cartridge 12, air conduit and waste conduit 56 may be opened for the insertion of a valve. Cartridge 12 further includes a security flap 68, which will be described in greater detail with reference to FIGS. 4A, 4B and 5.

Optionally, cartridge 12 may be formed from a polymer, optionally polypropylene. Cartridge 12 is preferably formed from a polymer which does not react with the treatment material or waste material which the cartridge is configured to contain. Cartridge 12 may be formed using a variety of techniques, optionally through molding techniques such as injection molding or compression molding. Optionally, cartridge 12 may be formed from other materials.

Reference is now made to FIG. 3B. Cartridge 12 is depicted, after filling and insertion of valves into conduits. Cartridge 12 has an air valve 62 and a waste valve 64, situated within groove 40. Cartridge 12 further includes a digital tag 58 which serves as an identifier of the cartridge. Cartridge 12 includes a fluid valve 66 which has been inserted by making an aperture through fluid conduit 42a and securing fluid valve 66 in the place of the aperture of fluid conduit 42a. Optionally, the fluid valve is a press-fit valve fitting into the aperture of fluid conduit 42a. Alternatively, fluid valve may be inserted using alternate methods. Once conduit 42a has been opened and fluid valve 66 has been introduced, valve 66 is sealed in conduit 42a to prevent leakage of fluid from conduit 42a. Cartridge 12 is filled with a first ink suitable for dyeing using a digital dyeing process.

Reference is now made to FIG. 3C. A cartridge 70 is depicted, after filling and insertion of valves. Cartridge 70 has a fluid valve 72 which has been inserted by making an aperture through fluid conduit 42d and securing fluid valve 72 in the place of the aperture of fluid conduit 42d. Cartridge 70 is filled with a second ink, different in color than the first ink, suitable for dyeing. Cartridges 12 and 70 are similar with the exception that the location of the fluid valve is different, and that they are filled with different substances.

According to embodiments, other treatment liquids, not limited to inks are introduced into cartridges 12 and 70. Filling system 10 may be used for alternate liquids or treatment materials in a machine which uses such liquids or treatment materials.

During operation of filling system 10, cartridge 12, when inserted in dock 22, abutment 46 mates with groove 40. As cartridge 12 is completely inserted within dock 22, fluid valve 66 engages conduit housing 50 at conduit 52a.

The fluid valves, waste valves and air valves may each be any valves configured to have an open position, allowing for liquid (fluid) flow, or closed position, preventing fluid flow. The valves may be mechanically or electronically controlled. The valve unit may comprise a septum and a needle configured to puncture the septum, when in contact with the septum. After separation of the cartridge from the dock, the needle disengages from the septum, resealing the septum. A septum may be present on the cartridge and a needle on the dock, or alternatively, a needle may be present on the cartridge and a septum on the dock. Optionally, the valves may be spring-loaded. One type of valve which may be used is a spring-loaded valve. Optionally, the valve remains closed when not in contact with a surface external to the cartridge, and upon contact with an appropriate conduit, the spring of the valve is opened, allowing for transfer of fluid (liquid or air) into or out of the cartridge. When cartridge 12 is fully inserted within dock 22 as in FIG. 1A, air valve 62 engages air conduit 32 to allow air flow into cartridge 12. Conduit 52a may be flow connected to a first ink reservoir (not shown) which is flow connected to deliver the first ink to a digitally controlled dyeing head (not shown) configured to apply a colored composition to a substrate such as a thread. Alternatively, the conduit may be flow-connected to a dyeing head, a mixing unit or another receptacle. Insertion of cartridge 12 within dock 22 allows for opening of fluid valve 66 and air valve 62, thereby allowing flow of the first ink from cartridge 12 into conduit 52a while air flows into cartridge 12.

During operation of filling system 10, cartridge 70 may be introduced into dock 22 of filling system 10. As cartridge 70 is completely inserted within dock 22, fluid valve 72 engages conduit housing 50 at conduit 52d. When cartridge 70 is fully inserted within dock 22, air valve 62 engages air conduit 32 to allow air flow into cartridge 70. Conduit 52d may be flow connected to a second ink reservoir (not shown) which is flow connected to deliver the second ink to a digitally controlled dyeing head (not shown) configured to apply a colored composition to a thread. Alternatively, the conduit may be flow-connected to a dyeing head or a mixing unit, or other receptacle. Insertion of cartridge 70 within dock 22 allows for opening of fluid valve 72 and air valve 62, thereby allowing flow of second ink (ink) from cartridge 70 into conduit 52d.

In a digital dyeing process, a digital dyeing machine may have separate reservoirs for containing 2 or more inks or treatment materials at any time, optionally between 4 and 8 inks or treatment materials. Optionally, the digital dyeing machine may have more than 8 separate reservoirs, and up to 100 reservoirs. In addition, a digital dyeing machine may use other chemical agents or biological agents for treating thread, which may also be loaded into reservoirs via the filling system. In order to dye thread using a digital dyeing process, the digital dyeing machine may have reservoirs, each filled with inks or treatment materials. Mixtures of the inks or treatment materials in the vicinity of the dyeing head may be used to dye thread at the desired color or alternatively treat the thread with the treatment material. During a dyeing process, the introduction of a mistaken ink or treatment materials into a reservoir could cause contamination of the dyeing apparatus, leading to damage of the system and the dyeing process, or the treatment process. As mentioned previously, two cartridges 12 and 70, which are substantially similar but differ only in the positioning of the fluid valve in fluid conduit 42a or fluid conduit 42d, can be used with a single dock of a filling system, without the need for separate docks for every cartridge. The use of a single dock to fill reservoirs of a digital dyeing machine saves room in the system. Instead of requiring a dyeing machine having multiple docks for each different colored ink, one dock is sufficient, allowing the machine to be more compact. In addition, a manufacturer of filled cartridges for use in the disclosed filling system needs to manufacture only one type of cartridge for multiple types of ink. Rather than manufacturing multiple differently sized cartridges for use with a filling system, a manufacturer may make only one type of cartridge for all treatment materials and adapt each cartridge to treatment materials by varying the aperture opened within the cartridge, and the subsequent placement of the valve. Such a filling system may be used for any system using a plurality of liquids, such as treatment materials or inks, which are unique from one another. This filling system allows a user to conveniently keep unique fluids from unintentionally mixing with each other.

Once emptied from its contents, cartridge 12 can be used to collect waste from a process of applying a treatment liquid, optionally a digitally controlled dyeing process. The waste may comprise spent ink or residual ink or treatment material.

An empty cartridge such as cartridge 16 or 18 is inserted into dock 26 and/or 28 for waste collection. In order to dispose of the waste such as residual inks or treatment materials, the collected waste may be conveyed, via a conduit, to waste conduit 34 in port 26 or 28. Cartridges 16 and 18, when inserted in ports 26 and 28 respectively, allow for flow of waste fluid from conduit 34 into waste valve 64 of cartridges 16 and 18. While cartridges 16 and 18 are inserted in ports 26 and 28 respectively, air valve 62 is engaged by air conduit 32 to allow air to escape cartridges while waste fluid enters. Upon completion of filling of cartridges 16 and 18 with waste fluid, new cartridges may be placed into docks 26 and 28 for waste collection.

The use of empty cartridges to fill with waste is advantageous to a user of a dyeing machine equipped with filling system 10. A user of a dyeing or printing machine, optionally a digital dyeing system equipped with filling system 10 purchases inks in cartridges. After the cartridges are emptied, they then serve an additional function to collect waste from the dyeing process. No separate waste containers need to be procured to dispose of waste fluid from the digital dyeing process. Any used cartridge may be placed in a dock for waste collection.

An additional advantage of cartridge 12 is the location of the fluid valve in a position which is protected from impact, by rim 44 which extends distally beyond fluid valve.

Digital tag 58 may include unique digitally encoded data that may prevent a used cartridge or a non-authenticated cartridge to be re-introduced into the dock. Potentially, the cartridge may be filled with harmful materials. For example, digital tag 58 may include a radio frequency identification (RFID) tag. Digital dyeing machine may be equipped with an RFID reader (not shown) to identify the uniquely encoded data associated with the RFID tag. The cartridge manufacturer may encode a unique digital number on an RFID tag associated with each cartridge manufactured. The reader may identity the RFID tag and associate the digitally encoded data with data approved by the manufacturer of the machine, indicating that the RFID is associated with an approved cartridge. The unique digital number on the RFID tag may then be recorded and designated as “used” after the cartridge has filled the dyeing machine. If the reader identifies an RFID tag designated as “used” in a subsequent filling of the dyeing machine, the dyeing machine may indicate to the user that the cartridge has been used, potentially indicating that the cartridge has been filled with counterfeit ink or treatment material, not supplied by the manufacturer. A user of the dyeing machine may be alerted and withdrawal of ink or treatment material from the cartridge may be halted by the dyeing machine. The RFID tag may therefore serve as an additional security measure to make sure that the dyeing machine is filled only using authenticated cartridges from the manufacturer. Other digital, electronic or optical encoding means may be used instead of or in addition to RFID.

Filling system 10 also has unique security measures to prevent insertion of a cartridge that has been filled with waste into a cartridge dock 22, configured to receive the cartridge and transfer the ink or treatment material from the cartridge to the machine. If a waste cartridge is accidentally inserted into dock 22, allowing waste to flow into an ink or treatment material reservoir, damage to the machine would be caused.

Embodiments described herein refer to a security element on a cartridge. In one embodiment the security element can be in the form of a movable physical element which assumes a position upon introduction into dock 26 or 28, thereby preventing introduction of the cartridge into dock 22. One form of security measure may be a security flap 68 as shown with reference to cartridge 12. Cartridge 12 with security flap 68 has been depicted in FIG. 3A.

Reference is now made to FIGS. 4A and 4B, which depict an enlarged view of cartridge 12, focused on security flap 68 and its vicinity. Cartridge 12 may include a plurality of tabs 90, and a plurality of indentations 92. Security flap 68 has a hinge 93, a plurality of legs 94 and a heel 96.

FIG. 5 depicts a schematic diagram of bay 20 and security features associated with bay 20. Bay 20 has docks 22, 26 and 28, which respectively have abutments 46, 47 and 48, as previously described with reference to FIGS. 1A and 1B. As described previously, dock 22 is configured to hold an ink or treatment material-filled cartridge, which is emptied into dyeing machine via conduit housing 50, and docks 26 and 28 are each configured to hold an emptied cartridge 16 and 18 which is then filled with waste from the machine, via waste conduit 34.

Returning to FIG. 5, docks 26 and 28 have a different configuration than dock 22. Docks 26 and 28 each include a plurality of wedges 98 protruding from inner surface of the respective docks. Wedges 98 are wedge-shaped members which remain in place in docks 26 and 28 when cartridges are inserted into the docks. Other configurations of members may be used. Wedges are not present in dock 22. Furthermore, the configuration of abutment 46 is different than that of abutments 47 and 48. Abutment 46 has an upper surface 45. Abutments 47 and 48 have upper surfaces 49. Upper surface 45 of abutment 46 extends further in the medial direction, as indicated by distance x, than upper surfaces 49, as indicated by distance y. Distance x is larger than distance y.

During the operation of bay 20, an ink-filled (or treatment material-filled) cartridge is inserted into dock 22. The configuration of security flap 68 is as in FIG. 4A, with legs 94 located medially relative to tabs 90. After emptying, the cartridge is then inserted into one of docks 26 or 28 to be filled with waste via waste conduit 34. Upon insertion, heel 96 of security flap 68 contacts wedges 98, forcing security flap 68 to pivot on hinge 93, and forcing legs 94 in the lateral direction, past tabs 90 and into indentations 92, to present in the locked configuration seen in FIG. 4B. Once legs 94 are located within indentations 92, in the locked position, considerable force is needed to return legs 94 to the unlocked position shown in FIG. 4A, with legs 94 located medially relative to tabs 90.

After a cartridge has been filled with waste, in docks 26 or 28, it may be mistaken for an ink-filled cartridge or treatment material filled cartridge by an operator of a dyeing machine and may be mistakenly inserted into dock 22. If such an insertion were possible, the mistake would then lead to flow of waste ink or treatment material from the cartridge into the system. The associated damage caused would be difficult to fix.

Security flap 68 and associated security features of the cartridge prevent such a mistaken insertion of a waste-filled cartridge into dock 22 as follows: Once legs 94 are located within indentations 92, heel 96 protrudes laterally into groove 40. This lateral protrusion does not interfere with insertion of cartridge into docks 26 or 28 or removal of cartridge therefrom. As seen in FIG. 5. Upper surface 45 of abutment 46 (dock 22) extends further in the medial direction, as indicated by distance x, than upper surfaces 49(docks 26 and 28) as indicated by distance y. When a cartridge which has been filled with waste and configured as in FIG. 4B with heel 96 protruding laterally into groove 40, is inserted into dock 20, heel 96 will abut against upper surface 45, thereby preventing complete insertion of the cartridge into dock 20. As a result, contents of the waste-filled cartridge will not enter the dyeing machine, thereby preventing damage to the machine.

Other mechanical security means could be used to prevent mistaken insertion of a waste-filled cartridge into a dock for conveying ink.

Some embodiments relate to a liquid management system for conveying a plurality of unique treatment liquids, comprising:a first receptacle adapted to receive a single cartridge, the receptacle having multiple conduits, each conduit configured to transport a unique treatment liquid, and each conduit corresponding to a different position on a cartridge; a plurality of cartridges configured to contain a liquid, the cartridges each comprising a flow outlet located at a position in the cartridge corresponding to one of the conduits of the receptacle; wherein, when a filled cartridge is introduced into the receptacle, liquid may flow through the flow outlet and into one of the conduits of the receptacle. Optionally, each cartridge comprises multiple openable conduits, each conduit located at a position in the cartridge corresponding to one of the conduits of the first receptacle. Optionally, the flow outlet is formed in a cartridge by introduction of a valve in a conduit in the cartridge. Optionally, a plurality of openable conduits of the cartridge are sealed to prevent liquid flow through the cartridge conduits. Optionally, the plurality of cartridges is filled with a treatment material suitable for treating a substrate. Optionally, the treatment material is an ink. Optionally, a cartridge comprising a first treatment material comprises a flow outlet located at a first position in the cartridge corresponding to a first conduit of a first receptacle and wherein a cartridge comprising a second treatment material comprises a flow outlet located at a second position in the cartridge corresponding to a second conduit of the first receptacle. Optionally, the system comprises 2 or more cartridges, each cartridge containing a unique treatment liquid. Optionally, the valve is a mechanical valve which opens to allow liquid flow upon contact of the valve with a first receptacle. Optionally, the valve is a spring-loaded valve which opens to allow liquid flow upon contact of the valve with a conduit of the first receptacle. Optionally, the valve is an electronically controlled valve which opens to allow liquid flow upon contact of the valve with a conduit of the first receptacle. Optionally, the cartridge further comprises an air flow inlet which can be opened to allow flow of air into the cartridge when liquid is removed through the flow outlet and to allow flow of air out of the cartridge when liquid is introduced into the cartridge. Optionally, the first receptacle further comprises an air-flow conduit corresponding to the cartridge air flow inlet. Optionally, the system further comprising a second receptacle adapted to receive a single cartridge, the second receptacle having a waste outlet. Optionally, the cartridge further comprises a waste-flow conduit corresponding to the waste outlet of the second receptacle. Optionally, the waste-flow conduit comprises a valve which opens to allow liquid flow upon contact of the valve with the waste outlet of the second receptacle. Optionally, the system further comprises a security element which prevents introduction of a cartridge into a receptable. Optionally, the cartridge further comprises a movable security element in a first position which upon engagement of the cartridge with the second receptacle, assumes a second position, the security element in the second position preventing engagement of the cartridge with the first receptacle. Optionally, the security element comprises a flap. Optionally, the security element is pivotable on a hinge Optionally, the cartridge comprises an indentation and wherein the security flap comprises a leg. Optionally, the second receptacle comprises a member which moves the security flap from a first position to a second position. Optionally, the second position of the security flap is assumed upon entry of a leg of the security flap in the indentation upon engagement of the cartridge with the second receptacle. Optionally, the security element prevents introduction of a waste-filled cartridge into a first receptacle. Optionally, the valve is a mechanically controlled valve or an electronically controlled valve. Optionally, the system further comprises a digital tag encoding digital data, and a digital tag reader. Optionally, the digital tag is an RFID tag. Optionally, the RFID tag is attached to the cartridge.

Some embodiments relate to a cartridge for use with a liquid management system for conveying a plurality of unique liquids to a receptacle adapted to receive a single cartridge and having multiple conduits, each conduit configured to transport a unique liquid, and each conduit corresponding to a different position on a cartridge; the cartridge comprising a plurality of openable conduits, each conduit located at a position in the cartridge corresponding to one of the conduits of the receptacle. Optionally, the plurality of openable conduits are sealed to prevent liquid flow through the cartridge conduits, and one of the openable conduits is fitted with a valve to form a flow outlet in the cartridge; wherein, when a filled cartridge is introduced into the receptacle, liquid may flow through the flow outlet and into one of the conduits of the receptacle. Optionally, the cartridge is filled with a treatment material suitable for treating a substrate. Optionally, the treatment material is an ink. Optionally, the cartridge further comprises an air flow inlet which can be opened to allow flow of air into the cartridge when liquid is removed through the flow outlet and to allow flow of air out of the cartridge when liquid is introduced into the cartridge. Optionally, the cartridge further comprises a movable security element in a first position which upon engagement of the cartridge with a receptacle, assumes a second position, the security element in the second position preventing engagement of the cartridge with another receptacle. Optionally, the valve is a mechanically controlled valve or an electronically controlled valve. Optionally, the cartridge further comprises a digital tag encoding digital data, configured to be read by a digital tag reader in the vicinity of the receptacle. Optionally, the digital tag is an RFID tag.

Some embodiments relate to a method for applying a treatment material to a substrate comprising: introducing a substrate into a dyeing machine; filling the dyeing machine or printing machine using a liquid management system according to any one of claims 1 to 28 with a treatment material; and contacting the treatment material with the substrate using the dyeing machine or printing machine.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A liquid management system for conveying a plurality of unique treatment liquids, comprising:
a first receptacle adapted to receive a single cartridge, the receptacle having multiple conduits, each conduit configured to transport a unique treatment liquid, and each conduit corresponding to a different position on a cartridge;
a plurality of cartridges configured to contain a liquid, the cartridges each comprising a flow outlet located at a position in the cartridge corresponding to one of the conduits of the receptacle;
wherein, when a filled cartridge is introduced into the receptacle, liquid may flow through the flow outlet and into one of the conduits of the receptacle.

2. The liquid management system according to claim 1 wherein each cartridge comprises multiple openable conduits, each conduit located at a position in the cartridge corresponding to one of the conduits of the first receptacle.

3. The liquid management system according to claim 2 wherein the flow outlet is formed in a cartridge by introduction of a valve in a conduit in the cartridge, wherein the valve is a mechanical, spring-loaded, or electronically controlled valve.

4. The liquid management system according to claim 3 wherein a plurality of openable conduits of the cartridge are sealed to prevent liquid flow through the cartridge conduits.

5. (canceled)

6. The liquid management system according to claim 4 wherein the treatment liquid is an ink.

7. The liquid management system according to claim 1 wherein a cartridge comprising a first treatment liquid comprises a flow outlet located at a first position in the cartridge corresponding to a first conduit of a first receptacle and wherein a cartridge comprising a second treatment liquid comprises a flow outlet located at a second position in the cartridge corresponding to a second conduit of the first receptacle.

8. The liquid management system according to claim 1 comprising 2 or more cartridges, each cartridge containing a unique treatment liquid.

9-11. (Canceled)

12. The liquid management system according to claim 1 wherein the cartridge further comprises an air flow inlet which can be opened to allow flow of air into the cartridge when liquid is removed through the flow outlet and to allow flow of air out of the cartridge when liquid is introduced into the cartridge.

13. (canceled)

14. The liquid management system according to claim 1 further comprising a second receptacle adapted to receive a single cartridge, the second receptacle having a waste outlet.

15. The liquid management system according to claim 14 wherein the cartridge further comprises a waste-flow conduit corresponding to the waste outlet of the second receptacle.

16. The liquid management system according to claim 15 wherein the waste-flow conduit comprises a valve which opens to allow liquid flow upon contact of the valve with the waste outlet of the second receptacle.

17. The liquid management system according to claim 14 further comprising a security element which prevents introduction of a cartridge into a receptacle.

18. The liquid management system according to claim 17 wherein the cartridge further comprises a movable security element in a first position which upon engagement of the cartridge with the second receptacle, assumes a second position, the security element in the second position preventing engagement of the cartridge with the first receptacle.

19. The liquid management system according to claim 18 wherein the security element comprises a flap pivotable on a hinge.

20. (canceled)

21. The liquid management system according to claim 19 wherein the cartridge comprises an indentation and wherein the security flap comprises a leg, and wherein the second receptacle comprises a member which moves the security flap from a first position to a second position.

22. (canceled)

23. The liquid management system according to claim 21 wherein the second position of the security flap is assumed upon entry of a leg of the security flap in the indentation upon engagement of the cartridge with the second receptacle.

24. The liquid management system according to claim 17 wherein the security element prevents introduction of a waste-filled cartridge into a first receptacle.

25-28. (canceled)

29. A cartridge for use with a liquid management system for conveying a plurality of unique liquids to a receptacle adapted to receive a single cartridge and having multiple conduits, each conduit configured to transport a unique liquid, and each conduit corresponding to a different position on a cartridge;
the cartridge comprising a plurality of openable conduits, each conduit located at a position in the cartridge corresponding to one of the conduits of the receptacle; wherein the plurality of openable conduits are sealed to prevent liquid flow through the cartridge conduits, and one of the openable conduits is fitted with a valve to form a flow outlet in the cartridge;
wherein, when a filled cartridge is introduced into the receptacle, liquid may flow through the flow outlet and into one of the conduits of the receptacle.

30-33. (canceled)

34. The cartridge according to claim 29 further comprising a movable security element in a first position which upon engagement of the cartridge with a receptacle, assumes a second position, the security element in the second position preventing engagement of the cartridge with another receptacle.

35-37. (canceled)

38. A method for applying a treatment liquid to a substrate comprising:
introducing a substrate into a dyeing machine;
filling the dyeing machine or printing machine using a liquid management system according to claim 1 with a treatment liquid; and
contacting the treatment liquid with the substrate using the dyeing machine or printing machine.
